(19) United States
(12) Patent Application Publication
(10) Pub. No.: US 2024/0265660 A1
(43) Pub. Date: Aug. 8, 2024

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventor: SHUNICHI HOMMA, TOKYO (JP)

(21) Appl. No.: 18/565,569

(22) PCT Filed: Feb. 18, 2022
(86) PCT No.: PCT/JP2022/006697

§ 371 Date: Nov. 30, 2023

(30) Foreign Application Priority Data
Jun. 14, 2021 (JP) 2021-098991

(51) Int. Cl. G06T 19/20; G06T 7/73; G06T 19/00

(52) U.S. Cl. CPC G06T 19/20; G06T 7/75; G06T 19/006; G06T 2207/10028; G06T 2219/2004; G06T 2219/2021

(57) ABSTRACT

To enable a three-dimensional model to be superimposed on a target in an image with high accuracy.

An information processing apparatus of the present disclosure includes: a position specifying unit that acquires a first feature amount associated with a first vertex of a three-dimensional model having a plurality of the first vertices, and specifies a first position corresponding to the first vertex in a target image captured by a camera on the basis of the first feature amount; and a processor that projects the three-dimensional model on the target image and corrects a position where the first vertex is projected to the first position to deform the three-dimensional model projected on the target image.

### TECHNICAL FIELD

The present disclosure relates to an information processing apparatus, an information processing method, and a computer program.

### BACKGROUND ART

In an Augmented Reality (AR) application, it is important to accurately display and superimpose a content on an image obtained by capturing a thing or the like existing in a real environment. For example, when a subject such as a building is recognized by an object recognition technology, the AR application may highlight a contour line of the subject and superimpose and display the content in accordance with the contour line in order to visually notify a user of the recognition thereof.

In such an AR application, it is possible to perform a collision representation, a hidden representation, or the like, such as causing a character of virtual information to stand on the ground or the floor or causing a ball of virtual information to hit a wall or an object and bounce, by accurately aligning the real environment with three-dimensional model data.

However, such representations assume that a three-dimensional model is accurately created in advance on the basis of its original object or the like. In a case where there is an error between the three-dimensional model and the object as a target, it is not possible to accurately align the three-dimensional model with the target object.

In particular, in three-dimensional models created by Structure from Motion (hereinafter, SFM) that performs large-scale three-dimensional structure restoration using a large number of images as inputs, a local structure can be correctly restored, but a global structure is often distorted. For example, individual models included in a large-scale three-dimensional model are accurate, but there is a deviation in a relative positional relationship between the models in some cases. Therefore, in a case where the large-scale three-dimensional model is subjected to AR superimposition, there is a problem that an accurately superimposed representation is difficult such as inaccurate superimposition of some models.

Furthermore, even in a case where a three-dimensional model is accurately created, it is difficult to accurately superimpose the three-dimensional model in a case where an image or the like obtained by capturing a real environment used for alignment is distorted due to distortion of a lens of a camera or the like.

### CITATION LIST

### Patent Document

Patent Document 1: Japanese Patent Application Laid-Open No. 2020-166424
Patent Document 2: Japanese Patent Application Laid-Open No. 2020-042575
Patent Document 3: Japanese Patent Application Laid-Open No. 2014-123376

### SUMMARY OF THE INVENTION

### Problems to be Solved by the Invention

The present disclosure has been made in view of the above-described problems, and aims to enable a three-dimensional model to be superimposed on a target in an image with high accuracy.

### Solutions to Problems

An information processing apparatus of the present disclosure includes: a position specifying unit that acquires a first feature amount associated with a first vertex of a three-dimensional model having a plurality of the first vertices, and specifies a first position corresponding to the first vertex in a target image captured by a camera on the basis of the first feature amount; and a processor that projects the three-dimensional model on the target image and corrects a position where the first vertex is projected to the first position to deform the three-dimensional model projected on the target image.

An information processing method of the present disclosure includes: acquiring a first feature amount associated with a first vertex of a three-dimensional model having a plurality of the first vertices, and specifying a first position corresponding to the first vertex in a target image captured by a camera on the basis of the first feature amount; and projecting the three-dimensional model on the target image and correcting a position where the first vertex is projected to the first position to deform the three-dimensional model projected on the target image.

A computer program of the present disclosure causes a computer to execute: a step of acquiring a first feature amount associated with a first vertex of a three-dimensional model having a plurality of the first vertices, and specifying a first position corresponding to the first vertex in a target image captured by a camera on the basis of the first feature amount; and a step of projecting the three-dimensional model on the target image and correcting a position where the first vertex is projected to the first position to deform the three-dimensional model projected on the target image.

### BRIEF DESCRIPTION OF DRAWINGS

FIG. 1 is a block diagram of an information processing system according to the present disclosure.

FIG. 2 is a view illustrating an example of a method for creating a three-dimensional model.

FIG. 3 is a view illustrating exemplary feature points detected from an image.

FIG. 4 is a view of a dense three-dimensional point cloud obtained from a sparse three-dimensional point cloud.

FIG. 5 is a view of vertices in a mesh model.

FIG. 6 is a view illustrating an example of a feature amount database regarding feature points of a three-dimensional model.

FIG. 7 is a view illustrating an example of a model database related to vertices and meshes of the three-dimensional model.

FIG. 8 is a view illustrating an example of matching between feature points in an image and feature points of a three-dimensional model.

FIG. 9 is a view illustrating an example in which a part of feature points of a three-dimensional model does not match a feature point on an image.

FIG. 10 is a view for describing a process of detecting a corresponding point of the feature point of the three-dimensional model.

FIG. 11 is a view illustrating an example in which a position where the feature point of the three-dimensional model is projected is corrected to a position of the corresponding point.

FIG. 12 is a view illustrating an example in which correction processing is not performed when a three-dimensional model is projected onto an image.

FIG. 13 is a view illustrating an example in which correction processing is not performed when a three-dimensional model is projected onto the image.

FIG. 14 is a view illustrating an example in which correction processing has been performed when the three-dimensional model is projected onto the image.

FIG. 15 is a diagram illustrating an example in which correction processing is not performed when a three-dimensional model is projected onto an image.

FIG. 16 is a view illustrating an example in which correction processing has been performed when the three-dimensional model is projected onto the image.

FIG. 17 is a flowchart of information processing system processing according to an embodiment of the present disclosure.

FIG. 18 is a diagram illustrating an example of a hardware configuration of the information processing apparatus of the present disclosure.

### MODE FOR CARRYING OUT THE INVENTION

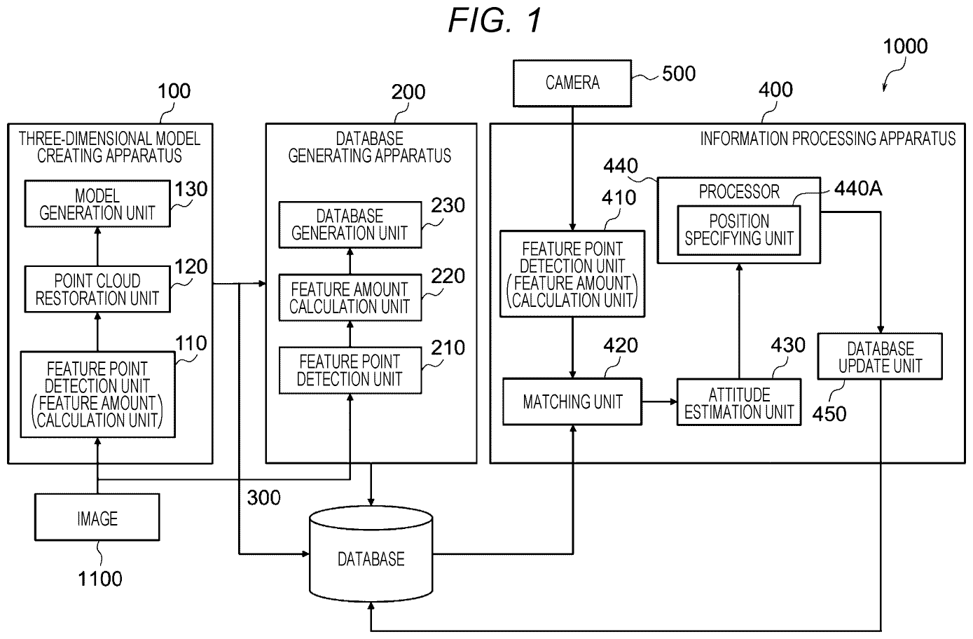

FIG. 1 is a block diagram of an information processing system 1000 according to an embodiment of the present disclosure.

The information processing system 1000 includes a three-dimensional model creating apparatus 100, a database generating apparatus 200, a database 300, an information processing apparatus 400, and a camera 500.

The three-dimensional model creating apparatus 100 includes a feature point detection unit 110, a point cloud restoration unit 120, and a model generation unit 130.

The database generating apparatus 200 includes a feature point detection unit 210, a feature amount calculation unit 220, and a database generation unit 230.

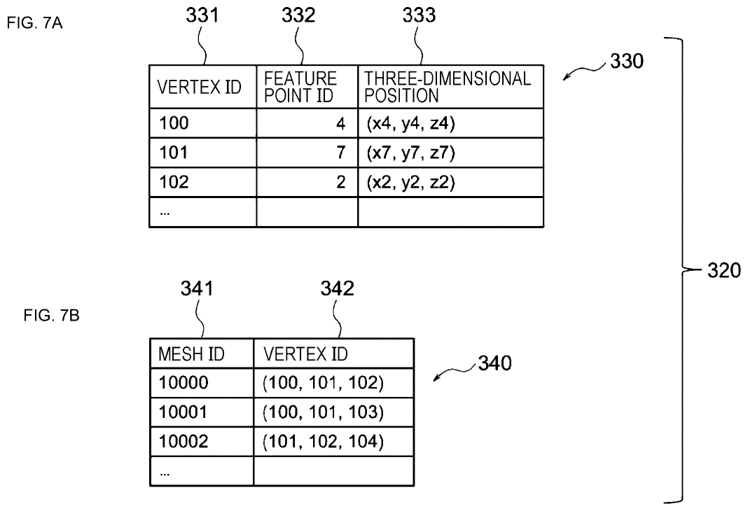

The database 300 includes a feature amount database 310 (first database) and a model database 320 (second database). The model database 320 according to the present embodiment includes two tables of a vertex table 330 and a mesh table 340 (see FIG. 7 as described later).

The information processing apparatus 400 includes a feature point detection unit (feature amount calculation unit) 410, a matching unit 420, an attitude estimation unit 430, a processor 440, and a database update unit 450.

In the present embodiment, in a case where a three-dimensional model created in advance is projected onto a projection target in an image (target image) acquired by the camera 500, a position where a vertex (feature point) of the three-dimensional model is projected is corrected using a feature amount related to the vertex. Therefore, a shape of a two-dimensional image of the three-dimensional model projected on the image is deformed, and the three-dimensional model is superimposed on the projection target included in the image with high accuracy. Here, as an example, the three-dimensional model is an object that can be created by Structure from Motion (SFM) or the like for restoring a three-dimensional structure with a plurality of images as inputs. Hereinafter, the three-dimensional model will be described.

### (Three-Dimensional Model)

The three-dimensional model is an object to be projected in accordance with a projection target (superimposition target) in an image in an AR application. The three-dimensional model has a plurality of vertices (first vertices). A feature amount (first feature amount) is associated with each of the vertices of the three-dimensional model.

More specifically, the three-dimensional model is represented by mesh data. The mesh data is data representing a set of planes (polygons) formed by connecting three or more vertices. The mesh data includes vertex data including positions of the vertices constituting each of the planes.

In the present embodiment, the three-dimensional model is created by performing processing such as Structure From Motion (SFM) for restoring a three-dimensional structure on the basis of a plurality of images 1100 obtained by capturing a model target (an object, an organism such as human, or the like) in a model reality space in a plurality of directions (angles).

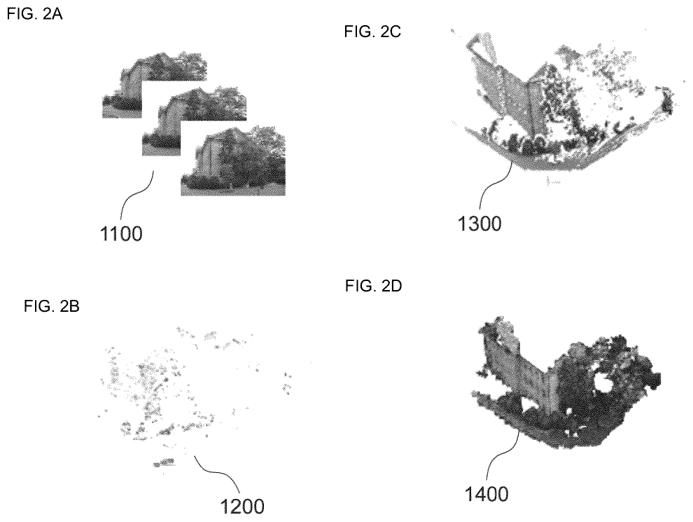

Hereinafter, a method by which the three-dimensional model creating apparatus 100 creates the three-dimensional model from the plurality of images 1100 by the SFM or the like will be described with reference to FIGS. 2 to 5.

FIG. 2 is a view illustrating an example of the method for creating the three-dimensional model.

The information processing system 1000 inputs the images 1100 as illustrated in FIG. 2(a) to the three-dimensional model creating apparatus 100. The input images 1100 are transmitted to the feature point detection unit 110 of the three-dimensional model creating apparatus 100.

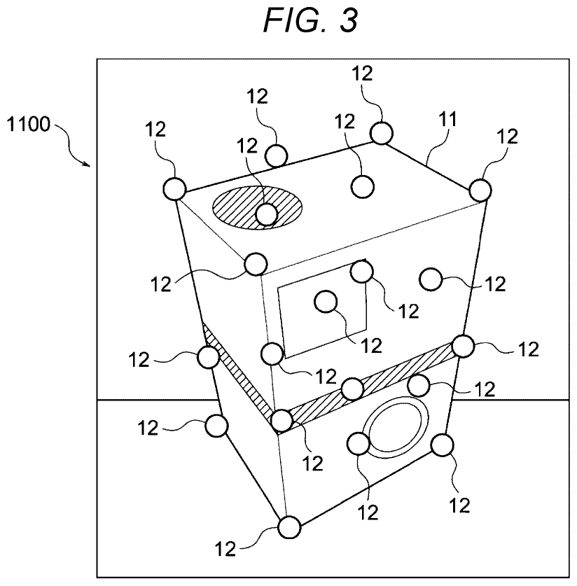

Here, the images 1100 are still images obtained by capturing a subject 11 (see FIG. 3) of a three-dimensional model, and are, for example, photographs. Furthermore, the images 1100 may be temporarily stopped moving images or the like other than the photographs.

FIG. 3 is a diagram illustrating one of images 1100 and a plurality of feature points in a target included in the image. Note that FIG. 3 illustrates an image obtained by capturing a target different from that in FIG. 2(a).

As illustrated in FIG. 3, the feature point detection unit 110 performs feature point detection processing to detect a plurality of feature points 12 from the image 1100. Here, the feature points 12 are, for example, a vertex included in the subject 11 of the model captured in the image 1100, a point that can be recognized from an appearance of the subject 11 such as a point with clear shading on the image, and the like. In the image 1100, the feature point detection unit 110 calculates a local feature amount from a local image (patch image) centered on each of the feature points 12. The feature point detection unit 110 includes a feature amount calculation unit that calculates the local feature amount.

The feature point detection unit 110 obtains a correspondence relationship of the feature points 12 (the same feature point) between the images 1100 on the basis of the local feature amounts respectively calculated from the plurality of images 1100. That is, the local feature amounts are compared to specify the feature points 12 at the same position between the different images 1100. Therefore, the feature point detection unit 110 can acquire a positional relationship between three-dimensional positions of the plurality of feature points and a positional relationship between the camera that captures each image and these feature points.

The feature point detection unit 110 transmits information of the plurality of detected feature points 12 (the three-dimensional positions of the feature points and the local feature amounts) to the point cloud restoration unit 120. Regarding a plurality of local feature amounts corresponding to the same feature point 12 obtained from the plurality of images 1100, the feature point detection unit 110 may transmit a representative value of the plurality of local feature amounts as the local feature amount of the feature point 12, or may transmit all or two or more of the plurality of local feature amounts.

The point cloud restoration unit 120 acquires the information of the plurality of feature points 12 transmitted from the feature point detection unit 110. The point cloud restoration unit 120 obtains a plurality of vertices indicating the three-dimensional positions obtained by projecting the plurality of feature points 12 in a three-dimensional space as a sparse three-dimensional point cloud 1200. FIG. 2(b) illustrates an example of the sparse three-dimensional point cloud 1200.

The point cloud restoration unit 120 may use bundle adjustment to obtain more accurate three-dimensional positions of feature points 13 (first vertexes) of the three-dimensional model from the sparse three-dimensional point cloud 1200. Furthermore, the point cloud restoration unit 120 can create a dense three-dimensional point cloud 1300 from the sparse three-dimensional point cloud 1200 using a means such as Multi-View Stereo (MVS). FIG. 2(c) illustrates an example of the dense three-dimensional point cloud 1300.

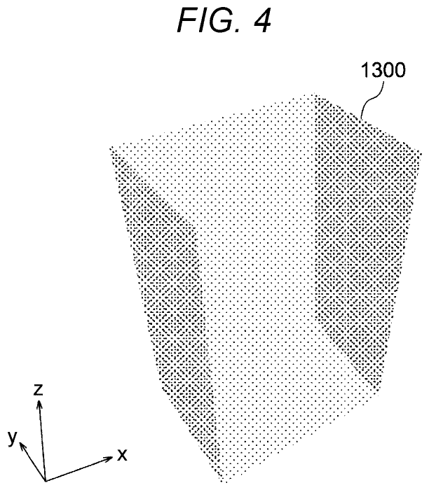

FIG. 4 illustrates an example of a dense three-dimensional point cloud obtained from a sparse three-dimensional point cloud in a case where a target of a three-dimensional model is the object illustrated in FIG. 3. Note that the process of creating a dense three-dimensional point cloud may be omitted.

The point cloud restoration unit 120 transmits information of the sparse three-dimensional point cloud 1200 or the three-dimensional point cloud 1300 to the model generation unit 130. Note that, in a case where the dense three-dimensional point cloud 1300 is created, an increased point (vertex) is also treated as a feature point, and a feature amount of the feature point can be obtained by interpolation from the original feature point.

The model generation unit 130 creates a three-dimensional model (a three-dimensional model 1400) formed by mesh data as illustrated in FIG. 2(d) on the basis of the information of the sparse three-dimensional point cloud 1200 or the three-dimensional point cloud 1300. Specifically, the model generation unit 130 connects three points to form each of planes (polygons) on the basis of positions of three-dimensional points included in the sparse three-dimensional point cloud 1200 or the dense three-dimensional point cloud 1300. Next, the three-dimensional model creating apparatus 100 collects the planes (polygons) to create the mesh data and obtain the three-dimensional model.

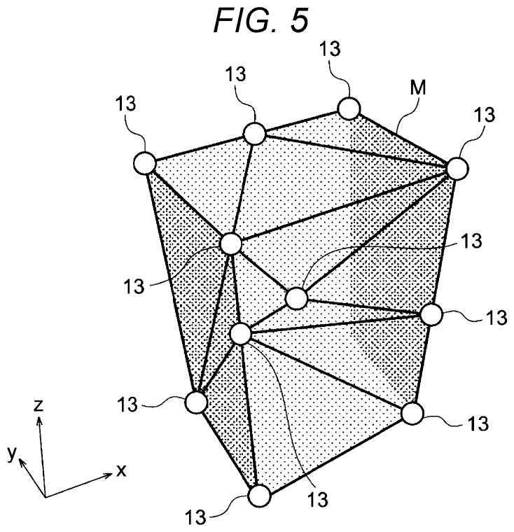

FIG. 5 illustrates an example of the feature points (the respective vertices constituting each of the planes) in the three-dimensional model.

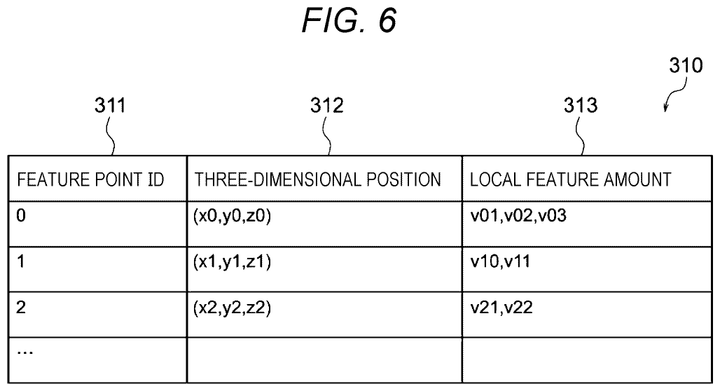

FIG. 6 is a database (feature amount database) including information (three-dimensional positions, local feature amounts of vertices, and the like) regarding the vertices (feature points) of the three-dimensional model. FIG. 7 is a database (model database) including information regarding the vertices and meshes of the three-dimensional model. These databases are generated by the database generating apparatus 200.

Hereinafter, a method by which the database generating apparatus 200 creates the feature amount database and a model database model will be described. Note that the three-dimensional model creating apparatus 100 and the database generating apparatus 200 are separated from each other, in the present embodiment, but may be integrated. In this case, a model three-dimensional model creating apparatus 100 may create the feature amount database and the model database on the basis of information regarding the feature points and meshes acquired at the time of creating the three-dimensional model.

The database generating apparatus 200 acquires information of the three-dimensional model created by the three-dimensional model creating apparatus 100 and the images 1100.

The feature point detection unit 210 detects positions (points) on the images 1100 corresponding to the respective vertices (feature point) constituting the three-dimensional model. For example, the positional relationship between the camera that captures each image and the feature point of the three-dimensional model acquired at the time of generating the three-dimensional model may be used. Alternatively, the feature point detection unit 210 may divert a feature point that has been already detected from the image by the three-dimensional model creating apparatus 100.

The feature amount calculation unit 220 calculates a local feature amount of the detected position (point) from each of the images 1100 in a similar manner to the above-described method. The feature amount calculation unit 220 transmits the calculated local feature amount to the database generation unit 230 in association with the feature point. The local feature amount associated with the feature point may be a representative value of a plurality of the local feature amounts obtained from the plurality of images 1100. Alternatively, all of the plurality of local feature amounts or two or more local feature amounts selected from the plurality of local feature amounts may be used. Note that the feature amount calculation unit 220 may use the local feature amounts that have been already calculated by the three-dimensional model creating apparatus 100.

The database generation unit 230 creates a feature amount database 310 (first database) in which the information regarding the feature points as illustrated in FIG. 6 is recorded and a model database 320 (second database) in which the information regarding the vertices and the meshes as illustrated in FIG. 7 is recorded.

The feature amount database 310 includes a column 311 in which a unique feature point ID for identifying a feature point is recorded, a column 312 in which a three-dimensional position of the feature point is recorded, and a column 313 in which a local feature amount of the feature point is recorded.

The model database 320 includes a vertex table 330 including data of the vertices constituting each of the meshes as illustrated in FIG. 7(a) and a mesh table 340 as illustrated in FIG. 7(b).

The vertex table 330 includes a column 331 in which a unique vertex ID for identifying a vertex of a mesh is recorded, a column 332 in which a feature point ID corresponding to the vertex is recorded, and a column 333 in which a three-dimensional position is recorded.

The mesh table 340 includes a column 341 in which a unique mesh ID for identifying a mesh is recorded and a column 342 in which vertex IDs of vertices constituting the mesh is recorded.

The feature amount database 310 and the model database 320 are associated with each other on the basis of the vertex ID. For example, in a case where a mesh of a surface of the three-dimensional model is specified, vertices constituting the mesh, and three-dimensional positions and local feature amounts of the vertices (feature points) can be specified from a mesh ID thereof.

The information processing apparatus 400 performs a process of projecting the three-dimensional model onto an image captured by the camera and superimposing the three-dimensional model on the image with high accuracy.

The feature point detection unit 410 of the information processing apparatus 400 in FIG. 1 acquires an image 510 (target image) captured by the camera 500.

The feature point detection unit 410 detects a plurality of feature points 511_1 from the image 510 by feature point detection, and calculates local feature amounts of the feature points 511_1. The feature point detection unit 410 transmits information (position information, the local feature amounts, and the like) regarding the feature points 511_1 to the matching unit 420. Note that the feature points 511_1 may be feature points obtained by performing feature point detection on the entire image 510, or may be feature points obtained by specifying an image portion corresponding to a building by semantic segmentation or the like and performing feature point detection on the specified image portion.

The matching unit 420 acquires the information (the position information, the local feature amounts, and the like) regarding the feature points 511_1 detected from the image 510 from the feature point detection unit 410. The matching unit 420 acquires a plurality of feature points 511_2 (first vertices) and local feature amounts (first feature amounts) of the three-dimensional model recorded in the database 300.

The matching unit 420 compares the local feature amounts of the feature points on the three-dimensional model with the local feature amounts of the feature points 511_1, and matches the corresponding feature points with each other.

In a case where a difference between the local feature amount of the feature point of the three-dimensional model and the local feature amount of the feature point 511_1 is less than a threshold, the matching unit 420 determines that both feature points are feature points matching each other, and specifies both the feature points. The matching unit 420 transmits information regarding the matched feature points to the attitude estimation unit 430.

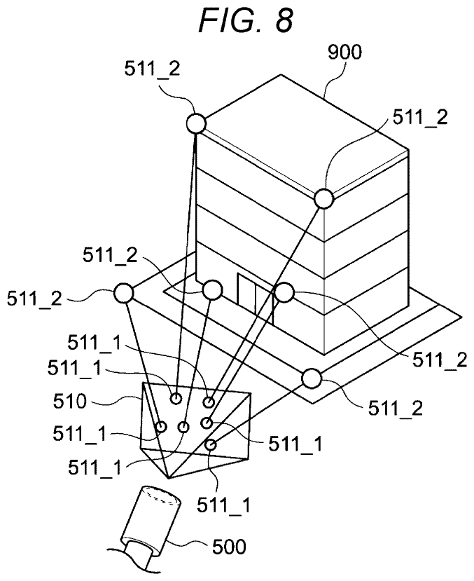

FIG. 8 is a view schematically illustrating an example in which feature points in an image captured by the camera are matched with feature points of a three-dimensional model. A situation in which the feature points 511_1 included in the image 510 acquired by the camera 500 and the feature points 511_2 included in a three-dimensional model 900 of a building all match is illustrated.

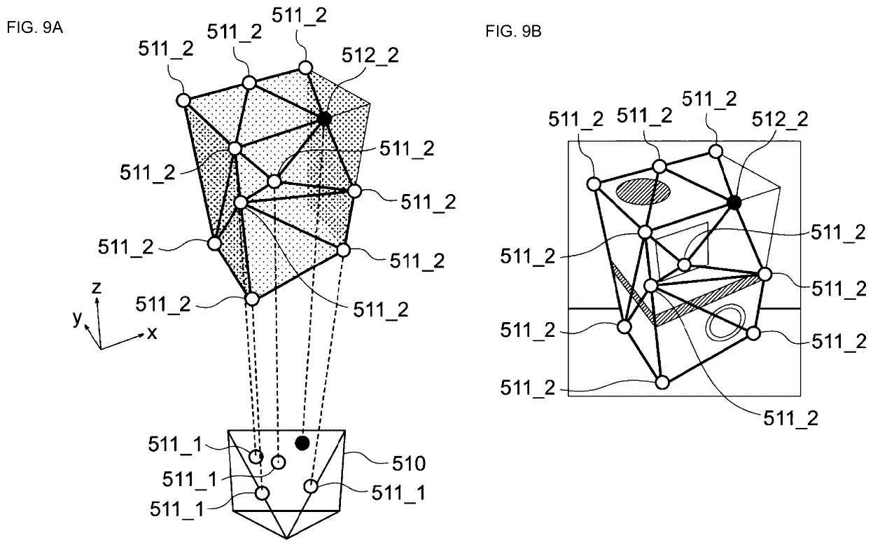

FIG. 9(a) is a view illustrating an example in which a part of feature points of a three-dimensional model is not matched in a case where the feature points of the three-dimensional model are matched with feature points in the image. For example, the feature points 511_2 in the three-dimensional model are matched with the feature points 511_1 in the image, but a feature point 512_2 in the three-dimensional model is not matched. Note that FIG. 9(b) will be described later.

The attitude estimation unit 430 estimates an attitude of the camera 500 that has captured the image 510. More specifically, the attitude estimation unit 430 estimates the attitude of the camera 500 on the basis of a plurality of pairs (N pairs) of a two-dimensional position of a feature point on the image and a three-dimensional position of a feature point of a three-dimensional model matched with the feature point.

For the estimation, for example, a PNP algorithm (PNP-RANSAC) using a random sampling consensus (RANSAC) framework can be used. A pair effective for the estimation is specified by excluding an outlier pair from the N pairs, and the attitude of the camera is estimated on the basis of the specified pair. The feature point of the three-dimensional model included in the pair used for the estimation corresponds to a point (feature point) that is an inlier in the PNP-RANSAC. The feature point of the three-dimensional model included in the pair not used for the estimation (the pair excluded as the outlier) corresponds to a point (feature point) that is an outlier in the PNP-RANSAC.

The processor 440 projects a three-dimensional model onto the image 510 according to the estimated attitude of the camera 500. A position where the feature point (point as the inlier) of the three-dimensional model used for the estimation of the attitude of the camera is projected on the image 510 coincides with or is close to the two-dimensional position of the feature point on the image paired with the point as the inlier. That is, it can be considered that the three-dimensional model and the image as a projection destination are consistent in the periphery of the position where the feature point as the inlier is projected.

On the other hand, a projected position on the image 510 of a feature point of the three-dimensional model that has not been used for the estimation of the attitude of the camera and a projected position on the image 510 of a feature point that has not been matched in the above-described matching processing may be greatly different from positions that should be originally present in the image plane. For example, there is a case where the projected positions greatly deviate from the positions that should be originally present in the image plane, or a case where a part of the three-dimensional model is not projected (does not appear) in the image due to a shielding object between the camera and a subject (subject in the real world) of the three-dimensional model. That is, it can be considered that the three-dimensional model and the image as the projection destination are not consistent in the periphery of the positions where the feature point as the outlier and the feature point that has not been matched are projected.

Hereinafter, feature points (including feature points that have not been matched in the matching processing) of the three-dimensional model that have not been used for the estimation of the attitude of the camera will be referred to as outlier feature points (vertices). Feature points of the three-dimensional model that have been used for the estimation of the attitude of the camera will be referred to as inlier feature points (vertices).

FIG. 9(b) illustrates an example in which the outlier feature point 5122 greatly deviates from a position (rightmost vertex of a rectangular box) where the feature point should be originally present in a case where the three-dimensional model of FIG. 9(a) is projected on the image.

The processor 440 projects the three-dimensional model on the image 510 captured by the camera 500, and corrects a projection destination position of the outlier feature point to an appropriate position. Therefore, a two-dimensional shape of the three-dimensional model projected on the image is deformed. Therefore, the three-dimensional model can be accurately superimposed on a projection destination target of the image. The processor 440 functions as a processor that deforms the three-dimensional model projected on the image by correcting the projection destination position of the outlier feature point in the three-dimensional model. Details of the processor 440 will be described hereinafter.

The processor 440 sets an area (referred to as an area A) centered on the projected position of the outlier feature point in the image on which the three-dimensional model is projected.

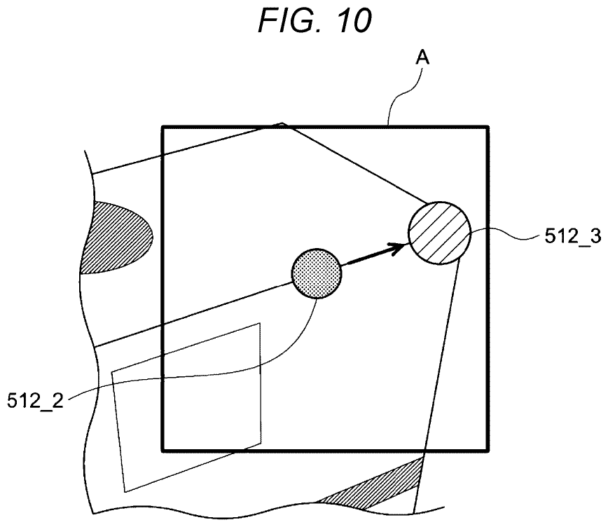

FIG. 10 illustrates an example of the surrounding area A centered on the position where the outlier feature point 512_2 is projected. The area A is a partial area of the image on which the three-dimensional model is projected. The area A is, for example, a rectangular area of M×M pixels.

The processor 440 calculates a local feature amount (second feature amount) for each of the pixels (positions) in the area A. Each of the pixels is sequentially selected to calculate a distance (distance in a feature space) or a difference between the local feature amount of the selected pixel and a local feature amount (first feature amount) of the outlier feature point 512_2. It is determined that a search for a corresponding point has succeeded if the distance is equal to or less than a threshold, or that the search for the corresponding point has failed if the distance is more than the threshold. The processor 440 sets a pixel (position) having the distance equal to or less than the threshold as the corresponding point, that is, a position (pixel) on the image corresponding to the outlier feature point 512_2. The processor 440 includes a position specifying unit 440A that specifies the position of the corresponding point. The processor 440 may end the search at a time point when the corresponding point is detected for the first time, or may search all the pixels in the area A and adopt a pixel with the smallest distance among the pixels whose distances are equal to or less than the threshold as the corresponding point.

The position of the searched corresponding point corresponds to a position (first position) corresponding to the outlier feature point (first vertex) in the image (target image) captured by the camera. The position specifying unit 440A acquires the first feature amount associated with the first vertex of the three-dimensional model having the plurality of first vertices, and specifies the first position (corresponding point) corresponding to the first vertex in the target image captured by the camera on the basis of the acquired first feature amount.

The processor 440 deforms a projection image of the projected three-dimensional model by moving the projected position of the outlier feature point to the position (pixel) of the searched corresponding point. As another method for deforming the projected image of the three-dimensional model, the following method is also available. That is, in this method, a position (three-dimensional position) of the outlier feature point described above is corrected in the three-dimensional model such that the projected position in the case of being projected on the image becomes the moved position (corrected position) described above. Then, the corrected three-dimensional model is projected again onto the image.

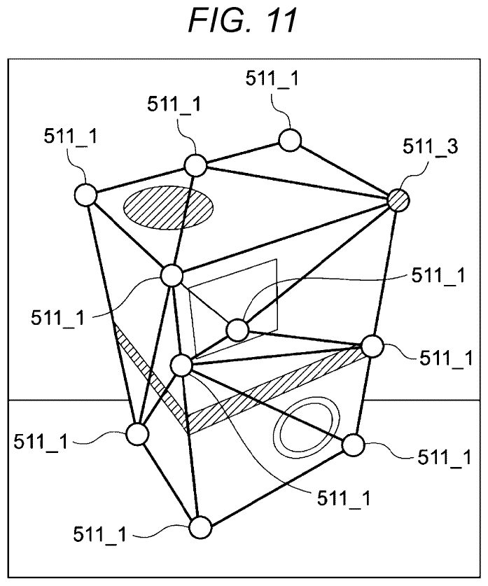

FIG. 11 illustrates an example in which the three-dimensional model projected on the image is deformed (the projected shape of the two-dimensional image of the three-dimensional model is changed) by moving (correcting) the position of the outlier feature point 512_2 of the three-dimensional model illustrated in FIG. 10 to a position 512_3. The feature point after the position change is illustrated as a feature point 511_3. In this manner, the three-dimensional model can be accurately made to coincide with a projection target in the image by deforming the projected image of the three-dimensional model.

Hereinafter, a projection example of a three-dimensional model in a case where a position of an outlier feature point is not corrected and a projection example of the three-dimensional model in a case where the position of the outlier feature point is corrected will be described.

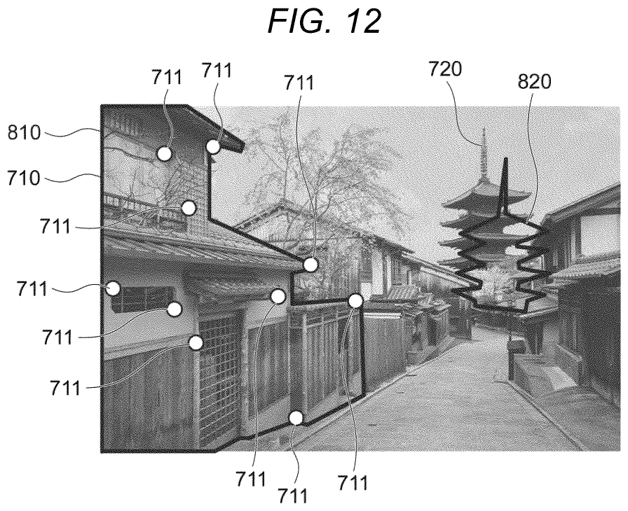

FIG. 12 illustrates an example in which a three-dimensional model is not accurately superimposed in a case where a projected position of an outlier feature point is not corrected. The three-dimensional model (large-scale three-dimensional model) includes two sub-models (three-dimensional models 810 and 820) as parts thereof. An example of projecting this large-scale three-dimensional model will be described. An image includes a building 710 in a near view and a building 720 in a distant view. An attitude of the camera is estimated using feature points (inlier feature points) of the three-dimensional model 810 corresponding to the building 710 in the near view. There is no outlier feature point in the three-dimensional model 810 corresponding to the near view, and feature points 711 of the three-dimensional model 810 are projected at or near positions of corresponding points in the image. As a result, the three-dimensional model 810 is accurately superimposed on a projection target in the image. On the other hand, all or some of feature points of the three-dimensional model 820 corresponding to the distant view are outlier feature points in this example, and a projection destination position of the three-dimensional model 820 is shifted from an original projection target. As a result, a projection area of the model 820 in the distant view greatly deviates from a position of the building 720 as the original projection target, and the three-dimensional model 820 is not accurately superimposed on the image. Note that illustration of the feature points (outlier feature points) of the three-dimensional model 820 is omitted in FIG. 12.

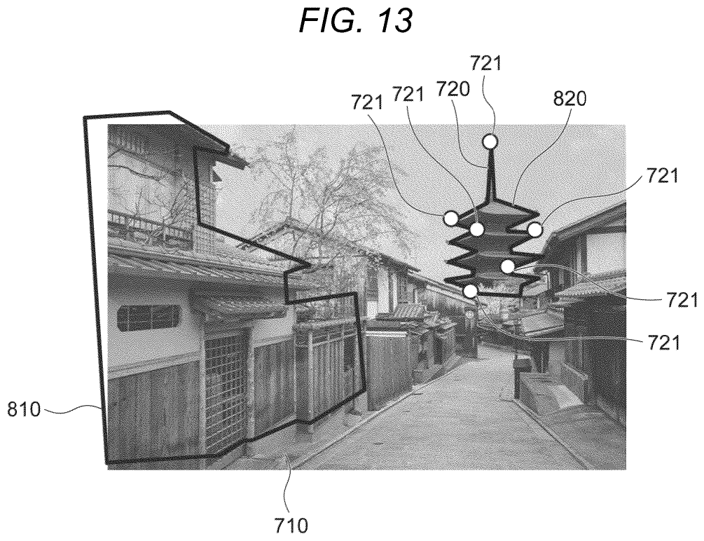

FIG. 13 illustrates an example in which a three-dimensional model is not accurately superimposed in a case where a projected position of an outlier feature point is not corrected. The three-dimensional model (large-scale three-dimensional model) includes two sub-models (three-dimensional models 810 and 820) as parts thereof. An example of projecting this large-scale three-dimensional model will be described. A position of the camera is estimated using feature points (inlier feature points) of the three-dimensional model 820 corresponding to the building 720 in the distant view. There is no outlier feature point in the three-dimensional model 820 corresponding to the distant view, and feature points 721 of the three-dimensional model 820 are projected at or near positions of corresponding points in the image. As a result, the three-dimensional model 820 is accurately superimposed on a projection target (an image portion of the building in the distant view) in the image. On the other hand, all or some of feature points of the three-dimensional model 810 corresponding to the near view are outlier feature points in this example, and a projection destination position of the three-dimensional model 810 is shifted from an original projection target. As a result, a projection area of the model 810 in the near view greatly deviates from a position of the building 710 as the original projection target, and the three-dimensional model 810 is not accurately superimposed on the image. Note that illustration of the feature points (outlier feature points) of the three-dimensional model 810 is omitted in FIG. 13.

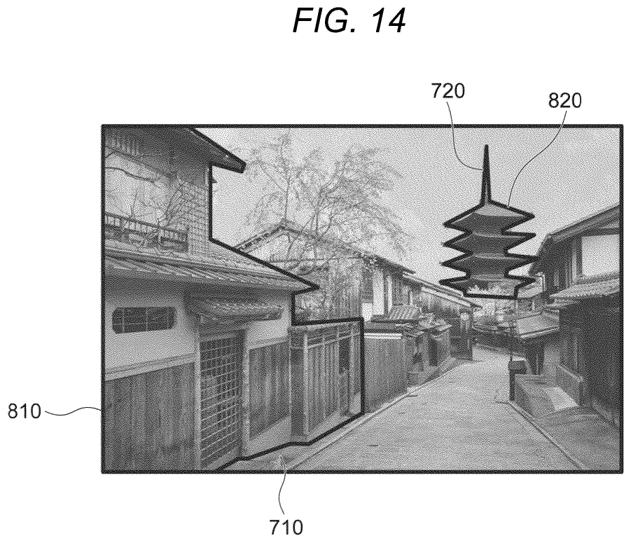

FIG. 14 illustrates an example in which correction processing according to the present embodiment is performed in the case of the example illustrated in FIG. 13. Positions where the outlier feature points of the three-dimensional model 810 are projected on the image are corrected to positions of the corresponding points described above. Therefore, a projected image of the three-dimensional model 810 is deformed, and the projected three-dimensional model 801 is accurately superimposed on the building 710 in the near view. Note that illustration of the feature points in the three-dimensional models 810 and 820 is omitted in FIG. 14.

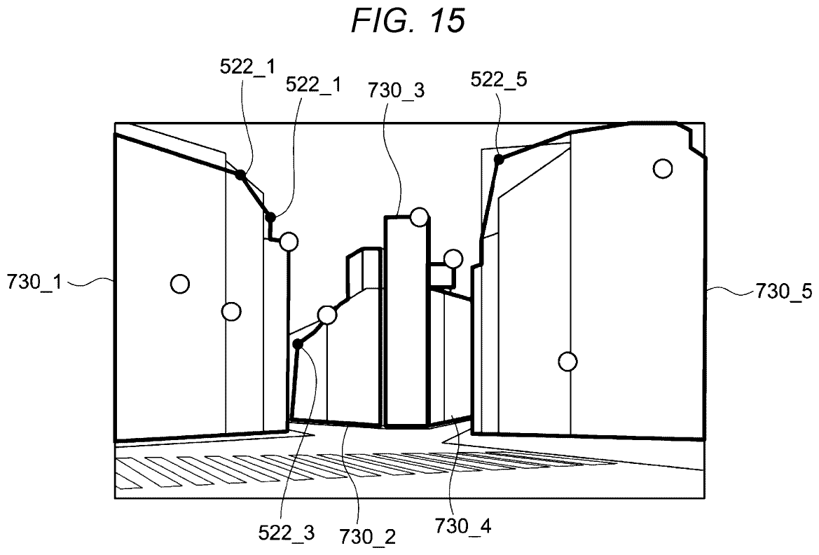

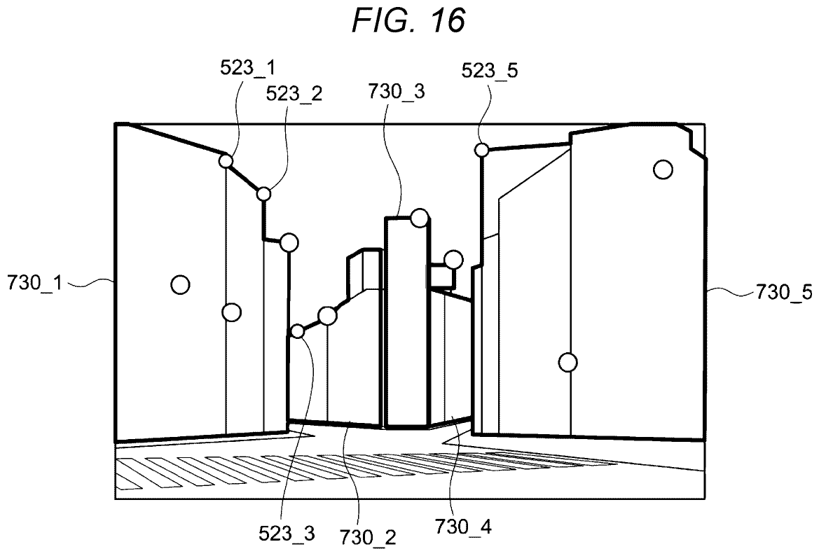

FIG. 15 illustrates another example of projecting a three-dimensional model without correcting positions of outlier feature points. FIG. 16 illustrates an example in which the positions of the outlier feature points in FIG. 15 are corrected.

FIG. 15 illustrates an example in which a large-scale three-dimensional model (including three-dimensional models 730_1 to 730_5 as parts thereof) is projected on an image. The three-dimensional models 730_1 to 730_5 correspond to buildings 830_1 to 830_5 as projection targets thereof, respectively. FIG. 15 illustrates outlier feature points 522_1, 522_2, 5223, and 522_5. As illustrated in FIG. 16, positions of these feature points are corrected to positions of corresponding points, respectively. The feature points 5221, 522_2, 5223, and 522_5 after the position correction are illustrated as feature points 5231, 5232, 5233, and 523_5 in FIG. 16. Therefore, the sub-models 730_1 to 730_5 included in the three-dimensional model are accurately superimposed on the buildings 830_1 to 830_5 as the projection targets thereof, respectively. Note that circled figures without reference signs in FIGS. 15 and 16 represent inlier feature points.

The database update unit 450 updates a position (three-dimensional position) of a vertex in a three-dimensional model, that is, updates a position of a feature point (vertex) registered in the database 300 on the basis of a corrected position (two-dimensional position) of a projected feature point. Note that a configuration in which the information processing apparatus does not include the database update unit 450 can be adopted. The database update unit 450 reflects position information of the feature point after the correction in mesh data of the three-dimensional model to change a mesh shape and correct the three-dimensional model itself.

Hereinafter, a method for converting a position (two-dimensional position) of a feature point corrected on a two-dimensional plane into a three-dimensional position will be described.

It is assumed that a three-dimensional position mPv of a feature point (for example, a vertex as an outlier) before correction in a model coordinate system is (x, y, z)^{T}, and an attitude of the camera 500 in the model coordinate system is (cRm, cPm).

At this time, a position cPv of the feature point (vertex) in a camera coordinate system is expressed as cRm·mPv+cPm. Here, cRm represents a 3×3 rotation matrix, and cPm represents a three-element translation vector.

A position p obtained by projecting the feature point (vertex) on an image is expressed as K·cPv using an internal parameter K of the camera, and a coordinate of the position p is (pₓ, p_{y})=(p₁/p₃, p₂/p₃). At this time, p₃ is a distance in the depth direction of the vertex cPv in the camera coordinate system. Furthermore, K is a 3×3 internal parameter matrix. Assuming that corrected coordinate of the feature point before correction on a two-dimensional image are (pₓ′, p_{y}′), a position cPv′ obtained by projecting this coordinate again on a three-dimensional space is K⁻¹ ((pₓ′, p_{y′}, 1)·p₃)^{T}.

This point is further converted from the camera coordinate system to the model coordinate system using mPx′=mRc·cPv′+mPc. It is satisfied that mRc=cRm^{T} and mPc=−wRc·cPm. Therefore, the position mPv of the feature point (vertex) before correction can be corrected to mPv′.

Since correct mesh data can be obtained by correcting the position of the vertex of the three-dimensional model in this manner, it is possible to accurately express an interaction between a real environment and virtual information (a three-dimensional model).

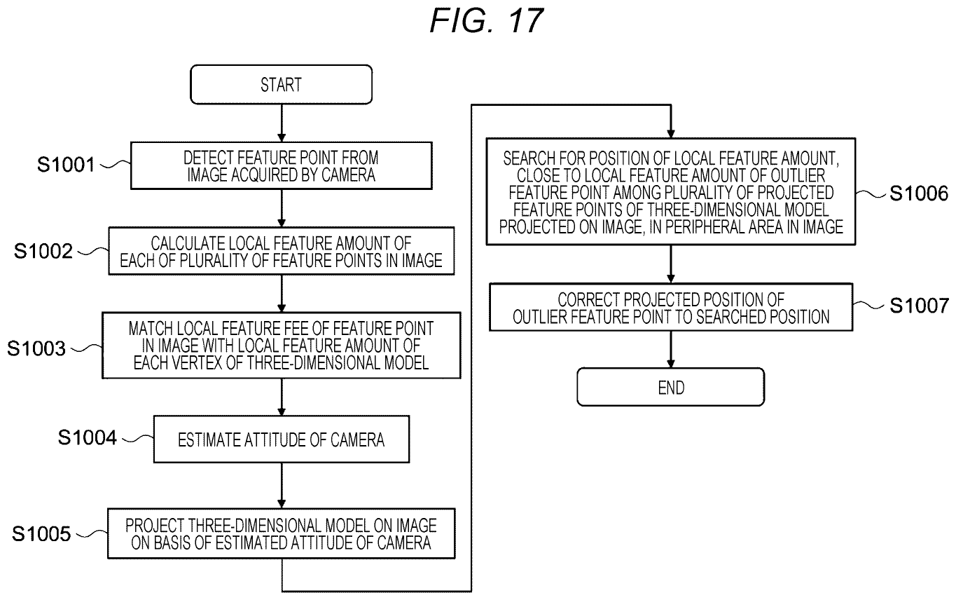

FIG. 17 is a flowchart illustrating an example of a processing flow of the information processing system 1000 according to the embodiment of the present disclosure.

First, the feature point detection unit 410 detects a plurality of feature points from one or more images 510 acquired by the camera 500 (S1001).

Next, the feature point detection unit 410 calculates a local feature amount of each of the plurality of feature points on the basis of the image 510 (S1002).

Next, the feature point detection unit 410 matches vertices (feature points) of a three-dimensional model with the feature points of the image 510 on the basis of the calculated local feature amounts and local feature amounts of the respective vertices (feature point) of the three-dimensional model recorded in the database 300 (S1003). The feature point detection unit 410 generates sets (pairs) of matched feature points (S1003).

Next, the attitude estimation unit 430 estimates an attitude of the camera 500 on the basis of the pairs of feature points (S1004).

Next, the processor 440 projects the three-dimensional model on the image 510 on the basis of the estimated attitude of the camera 500 (S1005). That is, the three-dimensional model is projected on the image 510 corresponding to the estimated attitude of the camera. Since the vertices (feature points) of the three-dimensional model included in the pairs described above are the vertices used for the camera estimation, these feature points are accurately projected on the image 510.

Next, the processor 440 specifies at least one or both of a feature point that is not matched with the feature point of the image 510 among the feature points of the three-dimensional model and a feature point of the three-dimensional model in a pair that is not used for the estimation of the attitude of the camera 500 among the pairs. The specified feature point corresponds to an outlier feature point. The processor 440 sets an area (referred to as an area A) centered on a position where the outlier feature point is projected, and calculates a local feature amount for each of positions (points) in the area A. The processor 440 searches for a position (point) where a difference from the local feature amount of the outlier feature point in the area A is equal to or less than a threshold (S1006).

Next, the processor 440 corrects the position where the outlier feature point is projected to the position searched in step S1006 (S1006). Therefore, a projection image of the three-dimensional model projected on the image is deformed, and the three-dimensional model is accurately superimposed on a target in the image 510.

As described above, according to the information processing apparatus of the present disclosure, the outlier feature point is detected from each of the feature points of the three-dimensional model captured in the image 510, and the position where the detected feature point is projected is corrected to the position of the pixel having the close or the same local feature amount of each of the pixels in the peripheral area. Therefore, the projection image of the projected three-dimensional model can be deformed, and the three-dimensional model can be superimposed (subjected to AR superimposition) on the projection target on the image with high accuracy.

### Modified Example

In the above-described embodiment, the information processing apparatus 400 reflects a correction result of a position of a feature point in a three-dimensional model in both the vertex table 330 (see FIG. 7(a)) in the model database and the feature amount database 310. In this modified example, a corrected position of a feature point in a three-dimensional model is reflected only in the vertex table 330.

A position of a feature point (vertex) projected on a camera image changes depending on lens distortion of the camera and how much correction of the distortion is correctly performed. Therefore, when the corrected position of the vertex corrected on the image is reflected in the feature amount database, there is a possibility that an originally correct position of the vertex is corrected to a wrong position. In this case, three-dimensional coordinates of the vertex in the feature point database, used for estimation of an attitude of the camera, and three-dimensional coordinates of the vertex in the vertex table are managed independently, and correction of a three-dimensional position of the vertex is reflected only in the vertex table. Therefore, the position of only the vertex used for AR superimposition can be corrected in accordance with characteristics of the camera.

### Application Example

Hereinafter, an application example of the information processing system 1000 will be described. Note that the above-described information processing system 1000 can also be applied to any system, device, method and the like of the information processing system 1000 below.

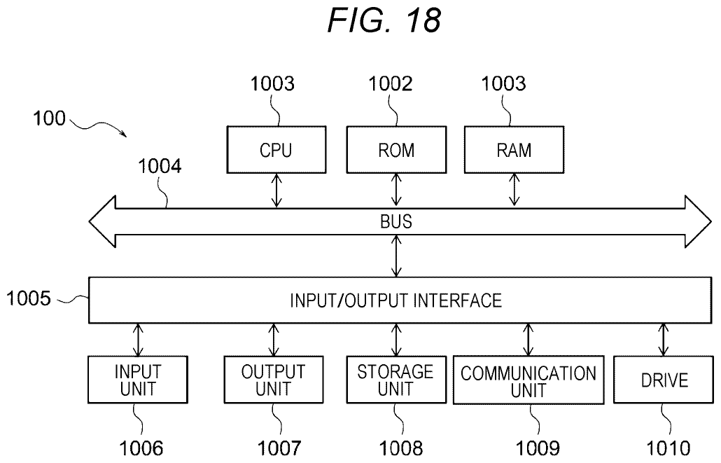

FIG. 18 illustrates an example of a configuration of hardware of a computer that executes a series of processing of the information processing system 1000 according to the present disclosure with a program. In the computer, a CPU 1001, a ROM 1002, and a RAM 1003 are connected to one another via a bus 1004.

An input/output interface 1005 is also connected to the bus 1004. An input unit 1006, an output unit 1007, a storage unit 1008, a communication unit 1009, and a drive 1010 are connected to the input/output interface 1005.

The input unit 1006 includes, for example, a keyboard, a mouse, a microphone, a touch panel, and an input terminal. The output unit 1007 includes, for example, a display, a speaker, and an output terminal. The storage unit 1008 includes, for example, a hard disk, a RAM disk, and a nonvolatile memory. The communication unit 1009 includes, for example, a network interface. The drive drives a removable medium such as a magnetic disk, an optical disk, a magneto-optical disk, or a semiconductor memory.

In the computer configured as described above, for example, the CPU 1001 loads a program stored in the storage unit 1008 into the RAM 1003 via the input/output interface 1005 and the bus 1004 and executes the program, and thus the above-described series of processing is performed. The RAM 1003 also appropriately stores data necessary for the CPU 1001 to execute various processing, and the like.

The program executed by the computer can be applied by being recorded on, for example, the removable medium as a package medium or the like. In this case, the program can be installed in the storage unit 1008 via the input/output interface 1005 by attaching the removable medium to the drive 1010.

Furthermore, this program can also be provided via a wired or wireless transmission medium such as a local area network, the Internet, or digital satellite broadcasting. In this case, the program can be received by the communication unit 1009 and installed in the storage unit 1008.

The steps of the processing disclosed in the present description may not necessarily be performed in the order described in the flowchart. For example, the steps may be executed in an order different from the order described in the flowchart, or some of the steps described in the flowchart may be executed in parallel.

Note that the present invention is not limited to the embodiment described above as it is, and can be embodied by modifying the components without departing from the gist thereof in the implementation stage. Furthermore, various inventions can be formed by appropriately combining the plurality of components disclosed in the embodiment described above. For example, some components may be deleted from all the components illustrated in the embodiment. Moreover, the components of different embodiments may be appropriately combined.

Furthermore, the effects of the present disclosure described in the present specification are mere examples, and other effects may be provided.

Note that the present disclosure can have the following configurations.

### [Item 1]

An information processing apparatus including:
a position specifying unit that acquires a first feature amount associated with a first vertex of a three-dimensional model having a plurality of the first vertices, and specifies a first position corresponding to the first vertex in a target image captured by a camera on the basis of the first feature amount; and
a processor that projects the three-dimensional model on the target image and corrects a position where the first vertex is projected to the first position to deform the three-dimensional model projected on the target image.

### [Item 2]

The information processing apparatus according to Item 1, further including
a feature amount calculation unit that calculates a second feature amount with respect to a position in the target image,
in which the position specifying unit specifies a position having the second feature amount whose distance from the first feature amount is equal to or less than a threshold in the target image, and sets the specified position as the first position.

### [Item 3]

The information processing apparatus according to Item 2, in which
the feature amount calculation unit calculates a second feature amount of each of a plurality of positions in a surrounding area of the position where the first vertex is projected, and
the position specifying unit specifies a position having the second feature amount whose distance from the first feature amount is equal to or less than a threshold, and sets the specified position as the first position.

### [Item 4]

The information processing apparatus according to Item 3, in which
the surrounding area is an area of a certain range centered on the projected position.

### [Item 5]

The information processing apparatus according to any one of Items 1 to 4, further including
a feature amount calculation unit that detects a plurality of feature points in the target image and calculates a plurality of second feature amounts for the plurality of feature points, respectively,
in which the position specifying unit includes an estimation unit that detects a feature point among the plurality of feature points, the feature point having the second feature amount whose distance from the first feature amount is equal to or less than a threshold, and estimates an attitude of the camera on the basis of a set of the first vertex and the detected feature point, and
the processor projects the three-dimensional model onto the target image on the basis of the attitude of the camera.

### [Item 6]

The information processing apparatus according to Item 5, in which
the estimation unit estimates the attitude of the camera on the basis of a PNP algorithm.

### [Item 7]

The information processing apparatus according to Item 6, further including:
a first database including a position of the first vertex and the first feature amount associated with the first vertex; and
a second database including the position of the first vertex,
in which the estimation unit estimates the attitude of the camera on the basis of the first database, and
the position specifying unit specifies the first position corresponding to the first vertex in the target image on the basis of the second database,
the information processing apparatus further including an update unit that converts the first position in the target image into a position in a three-dimensional model coordinate system and updates the position of the first vertex in the second database on the basis of the converted position.

### [Item 8]

The information processing apparatus according to Item 7, in which
the update unit updates the position of the first vertex in the first database on the basis of the changed position.

### [Item 9]

The information processing apparatus according to Item 7, in which
the update unit does not update the position of the first vertex in the first database.

### [Item 10]

The information processing apparatus according to any one of Items 1 to 9, in which
the three-dimensional model is a model having each of a plurality of feature points, detected by performing feature point detection on the basis of one or more images obtained by capturing a target, as the first vertex, and
the first feature amount associated with the first vertex is a feature amount calculated for the feature point.

### [Item 11]

An information processing method including:
acquiring a first feature amount associated with a first vertex of a three-dimensional model having a plurality of the first vertices, and specifying a first position corresponding to the first vertex in a target image captured by a camera on the basis of the first feature amount; and
projecting the three-dimensional model on the target image and correcting a position where the first vertex is projected to the first position to deform the three-dimensional model projected on the target image.

### [Item 12]

A computer program for causing a computer to execute:
a step of acquiring a first feature amount associated with a first vertex of a three-dimensional model having a plurality of the first vertices, and specifying a first position corresponding to the first vertex in a target image captured by a camera on the basis of the first feature amount; and
a step of projecting the three-dimensional model on the target image and correcting a position where the first vertex is projected to the first position to deform the three-dimensional model projected on the target image.

### REFERENCE SIGNS LIST

100 Three-dimensional model creating apparatus
110 Feature point detection unit
120 Point cloud restoration unit
130 Model generation unit
200 Database generating apparatus
210 Feature point detection unit
220 Feature amount calculation unit
300 Database
310 Feature amount database
320 Model database
330 Vertex table
340 Mesh table
400 Information processing apparatus
410 Feature point detection unit
420 Matching unit
430 Attitude estimation unit
440 Processor
500 Camera

1. An information processing apparatus comprising:
a position specifying unit that acquires a first feature amount associated with a first vertex of a three-dimensional model having a plurality of the first vertices, and specifies a first position corresponding to the first vertex in a target image captured by a camera on a basis of the first feature amount; and
a processor that projects the three-dimensional model on the target image and corrects a position where the first vertex is projected to the first position to deform the three-dimensional model projected on the target image.

2. The information processing apparatus according to claim 1, further comprising
a feature amount calculation unit that calculates a second feature amount with respect to a position in the target image,
wherein the position specifying unit specifies a position having the second feature amount whose distance from the first feature amount is equal to or less than a threshold in the target image, and sets the specified position as the first position.

3. The information processing apparatus according to claim 2, wherein
the feature amount calculation unit calculates a second feature amount of each of a plurality of positions in a surrounding area of the position where the first vertex is projected, and
the position specifying unit specifies a position having the second feature amount whose distance from the first feature amount is equal to or less than a threshold, and sets the specified position as the first position.

4. The information processing apparatus according to claim 3, wherein
the surrounding area is an area of a certain range centered on the projected position.

5. The information processing apparatus according to claim 1, further comprising
a feature amount calculation unit that detects a plurality of feature points in the target image and calculates a plurality of second feature amounts for the plurality of feature points, respectively,
wherein the position specifying unit includes an estimation unit that detects a feature point among the plurality of feature points, the feature point having the second feature amount whose distance from the first feature amount is equal to or less than a threshold, and estimates an attitude of the camera on a basis of a set of the first vertex and the detected feature point, and
the processor projects the three-dimensional model onto the target image on a basis of the attitude of the camera.

6. The information processing apparatus according to claim 5, wherein
the estimation unit estimates the attitude of the camera on a basis of a PNP algorithm.

7. The information processing apparatus according to claim 6, further comprising:
a first database including a position of the first vertex and the first feature amount associated with the first vertex; and
a second database including the position of the first vertex,
wherein the estimation unit estimates the attitude of the camera on a basis of the first database, and
the position specifying unit specifies the first position corresponding to the first vertex in the target image on a basis of the second database,
the information processing apparatus further comprising an update unit that converts the first position in the target image into a position in a three-dimensional model coordinate system and updates the position of the first vertex in the second database on a basis of the converted position.

8. The information processing apparatus according to claim 7, wherein
the update unit updates the position of the first vertex in the first database on a basis of the converted position.

9. The information processing apparatus according to claim 7, wherein
the update unit does not update the position of the first vertex in the first database.

10. The information processing apparatus according to claim 1, wherein
the three-dimensional model is a model having each of a plurality of feature points, detected by performing feature point detection on a basis of one or more images obtained by capturing a target, as the first vertex, and
the first feature amount associated with the first vertex is a feature amount calculated for the feature point.

11. An information processing method comprising:
acquiring a first feature amount associated with a first vertex of a three-dimensional model having a plurality of the first vertices, and specifying a first position corresponding to the first vertex in a target image captured by a camera on a basis of the first feature amount; and
projecting the three-dimensional model on the target image and correcting a position where the first vertex is projected to the first position to deform the three-dimensional model projected on the target image.

12. A computer program for causing a computer to execute:
a step of acquiring a first feature amount associated with a first vertex of a three-dimensional model having a plurality of the first vertices, and specifying a first position corresponding to the first vertex in a target image captured by a camera on a basis of the first feature amount; and
a step of projecting the three-dimensional model on the target image and correcting a position where the first vertex is projected to the first position to deform the three-dimensional model projected on the target image.
